(19) United States
(12) Patent Application Publication
(10) Pub. No.: US 2024/0396611 A1
(43) Pub. Date: Nov. 28, 2024

(54) INITIAL BEAM-PAIRING REFERENCE SIGNALS USING DESTINATION IDENTIFIERS

(71) Applicant: QUALCOMM Incorporated, San Diego, CA (US)

(72) Inventors: Kazuki TAKEDA, Minato-ku (JP); Sony AKKARAKARAN, Poway, CA (US); Jelena DAMNJANOVIC, Del Mar, CA (US); Hua WANG, Basking Ridge, NJ (US); Jae Ho RYU, San Diego, CA (US)

(21) Appl. No.: 18/625,594

(22) Filed: Apr. 3, 2024

Related U.S. Application Data
(60) Provisional application No. 63/503,887, filed on May 23, 2023.

(51) Int. Cl. H04B 7/06; H04L 1/00; H04W 4/46; H04W 72/25

(52) U.S. Cl. CPC H04B 7/0696; H04L 1/0061; H04W 4/46; H04W 72/25

(57) ABSTRACT

Various aspects of the present disclosure generally relate to wireless communication. In some aspects, a first user equipment (UE) may transmit, to a second UE, a reference signal used for initial beam-pairing (IBP) (IBP-RS) based at least in part on a destination identifier (ID), wherein one or more of an IBP-RS sequence, an IBP-RS configuration, or an IBP-RS resource is based at least in part on the destination ID. The first UE may receive, from the second UE and based at least in part on the IBP-RS, a beam-pairing response signal for a beam association. Numerous other aspects are described.

### CROSS-REFERENCE TO RELATED APPLICATION

This patent application claims priority to U.S. Provisional Patent Application No. 63/503,887, filed on May 23, 2023, entitled “INITIAL BEAM-PAIRING REFERENCE SIGNALS USING DESTINATION IDENTIFIERS,” and assigned to the assignee hereof. The disclosure of the prior application is considered part of and is incorporated by reference into this patent application.

### FIELD OF THE DISCLOSURE

Aspects of the present disclosure generally relate to wireless communication and to techniques and apparatuses for initial beam-pairing reference signals (IBP-RSs) using destination identifiers (IDs).

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (for example, bandwidth, transmit power, etc.). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

These multiple access technologies have been adopted in various telecommunication standards to provide a common protocol that enables different UEs to communicate on a municipal, national, regional, or global level. New Radio (NR), which also may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency-division multiplexing (OFDM) with a cyclic prefix (CP) (CP-OFDM) on the downlink, using CP-OFDM or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation.

### SUMMARY

Some aspects described herein relate to an apparatus for wireless communication at a first user equipment (UE) includes one or more memories; and one or more processors coupled to the one or more memories, the one or more processors individually or collectively configured to: transmit, to a second UE, a reference signal used for initial beam-pairing (IBP) (IBP-RS) based at least in part on a destination identifier (ID), wherein one or more of an IBP-RS sequence, an IBP-RS configuration, or an IBP-RS resource is based at least in part on the destination ID; and receive, from the second UE and based at least in part on the IBP-RS, a beam-pairing response signal for a beam association.

Some aspects described herein relate to an apparatus for wireless communication at a second UE includes one or more memories; and one or more processors coupled to the one or more memories, the one or more processors individually or collectively configured to: receive, from a first UE, an IBP-RS based at least in part on a destination ID, wherein one or more of an IBP-RS sequence, an IBP-RS configuration, or an IBP-RS resource is based at least in part on the destination ID; and transmit, to the first UE and based at least in part on the IBP-RS, a beam-pairing response signal for a beam association.

Some aspects described herein relate to a method of wireless communication performed by a first UE. The method may include transmitting, to a second UE, an IBP-RS based at least in part on a destination ID, wherein one or more of an IBP-RS sequence, an IBP-RS configuration, or an IBP-RS resource is based at least in part on the destination ID; and receiving, from the second UE and based at least in part on the IBP-RS, a beam-pairing response signal for a beam association.

Some aspects described herein relate to a method of wireless communication performed by a second UE. The method may include receiving, from a first UE, an IBP-RS based at least in part on a destination ID, wherein one or more of an IBP-RS sequence, an IBP-RS configuration, or an IBP-RS resource is based at least in part on the destination ID; and transmitting, to the first UE and based at least in part on the IBP-RS, a beam-pairing response signal for a beam association.

Some aspects described herein relate to a non-transitory computer-readable medium that stores a set of instructions for wireless communication by a first UE. The set of instructions, when executed by one or more processors of the first UE, may cause the first UE to transmit, to a second UE, an IBP-RS based at least in part on a destination ID, wherein one or more of an IBP-RS sequence, an IBP-RS configuration, or an IBP-RS resource is based at least in part on the destination ID; and receive, from the second UE and based at least in part on the IBP-RS, a beam-pairing response signal for a beam association.

Some aspects described herein relate to a non-transitory computer-readable medium that stores a set of instructions for wireless communication by a second UE. The set of instructions, when executed by one or more processors of the second UE, may cause the second UE to receive, from a first UE, an IBP-RS based at least in part on a destination ID, wherein one or more of an IBP-RS sequence, an IBP-RS configuration, or an IBP-RS resource is based at least in part on the destination ID; and transmit, to the first UE and based at least in part on the IBP-RS, a beam-pairing response signal for a beam association.

Some aspects described herein relate to a first apparatus for wireless communication. The first apparatus may include means for transmitting, to a second UE, an IBP-RS based at least in part on a destination ID, wherein one or more of an IBP-RS sequence, an IBP-RS configuration, or an IBP-RS resource is based at least in part on the destination ID; and means for receiving, from the second UE and based at least in part on the IBP-RS, a beam-pairing response signal for a beam association.

Some aspects described herein relate to a second apparatus for wireless communication. The second apparatus may include means for receiving, from a first UE, an IBP-RS based at least in part on a destination ID, wherein one or more of an IBP-RS sequence, an IBP-RS configuration, or an IBP-RS resource is based at least in part on the destination ID; and means for transmitting, to the first UE and based at least in part on the IBP-RS, a beam-pairing response signal for a beam association.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of establishing an initial beam-pairing (IBP), in accordance with the present disclosure.

FIG. 5 is a diagram illustrating an example of a unicast link establishment procedure, in accordance with the present disclosure.

FIG. 6 is a diagram illustrating an example associated with initial beam-pairing reference signals (IBP-RSs) using destination identifiers (IDs), in accordance with the present disclosure.

FIGS. 7-8 are diagrams illustrating example processes associated with IBP-RSs using destination IDs, in accordance with the present disclosure.

FIGS. 9-10 are diagrams of example apparatuses for wireless communication, in accordance with the present disclosure.

### DETAILED DESCRIPTION

An initial beam-pairing (IBP) may be performed before a sidelink unicast link establishment. A first user equipment (UE) (e.g., a transmit (Tx) UE) may transmit reference signals via different Tx beams. A second UE (e.g., a receive (Rx) UE) may measure the reference signals, and based at least in part on reference signal measurements, the second UE may determine a first UE Tx beam and/or a second UE Rx beam. In some cases, the second UE may determine a second UE Tx beam. The second UE may indicate, to the first UE, a determined first UE Tx beam. The first UE and the second UE may set up the sidelink unicast link using the determined first UE Tx beam based at least in part on an existing link establishment procedure.

In some cases, the first UE may perform an unnecessary IBP with irrelevant second UEs. The first UE may transmit the reference signals for IBP. The irrelevant second UEs, which may be around the first UE, may receive the reference signals from the first UE. The irrelevant second UEs may respond to the first UE to establish initial beam pairs. At a later time, during the unicast link establishment, the first UE may determine that the second UEs are irrelevant, which may cause a unicast link to not be established. However, performing (at least partially) unnecessary unicast link establishment procedures due to the irrelevant second UEs responding to the first UE may unnecessarily consume UE energy and radio resources, thereby degrading a performance of the first UE and/or the irrelevant second UEs.

Various aspects relate generally to determining a reference signal used for IBP IBP-RS using a destination identifier (ID). Some aspects more specifically relate to determining an IBP-RS sequence, an IBP-RS configuration, and/or an IBP-RS resource based at least in part on the destination ID, and for a frequency range 2 in sidelink (FR2-SL). In some examples, a first UE (e.g., a Tx UE) may determine the IBP-RS based at least in part on the destination ID. The destination ID may be a layer-2 destination ID, which may indicate a destination of a sidelink message associated with the destination ID. The destination ID may be a layer-2 ID of a receive (Rx) UE when the second UE is a target second UE. The IBP-RS sequence, the IBP-RS configuration, and/or the IBP-RS resource may be based at least in part on the destination ID. A level of uniqueness may be ensured for the IBP-RS, even before a start of a unicast link establishment procedure. For example, ID(s) or higher layer parameter(s) that are known by the first UE and the second UE may be used to derive the IBP-RS sequence, the IBP-RS configuration, and/or the IBP-RS resource, which may be aimed at filtering out irrelevant second UEs' processes. The first UE may transmit, to the second UE, the IBP-RS based at least in part on the destination ID. The second UE may initiate the unicast link establishment procedure based at least in part on a receipt of the IBP-RS.

Particular aspects of the subject matter described in this disclosure can be implemented to realize one or more of the following potential advantages. In some examples, by determining the IBP-RS based at least in part on the destination ID, the described techniques can be used to avoid unnecessary signaling from irrelevant second UEs (e.g., non-target second UEs). When the destination ID is the layer-2 ID of the second UE, an IBP process between the first UE and a non-target second UE may be avoided. When the destination ID is the service ID, an IBP process between the first UE and a second UE having no interest in a service associated with the service ID may be avoided. As a result, the irrelevant second UEs may not respond to the first UE based at least in part on the IBP-RS. The irrelevant second UEs may not respond to the first UE for the purpose of establishing IBPs, which may reduce a UE energy consumption and radio resources for both the first UE and the second UE.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

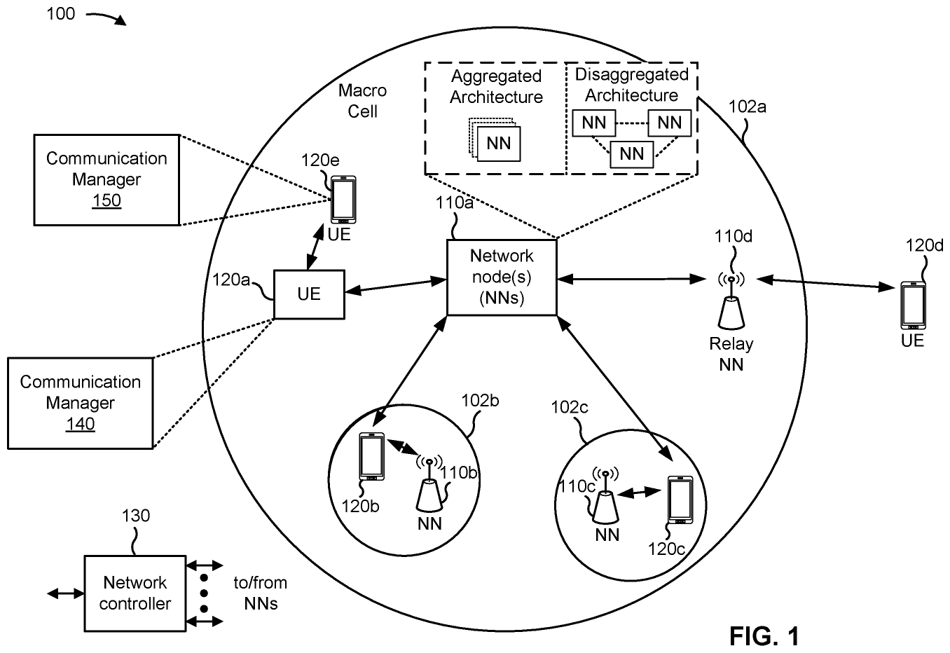

FIG. 1 is a diagram illustrating an example of a wireless network 100. The wireless network 100 may be or may include elements of a 5G (for example, NR) network or a 4G (for example, Long Term Evolution (LTE)) network, among other examples. The wireless network 100 may include one or more network nodes 110 (shown as a network node 110a, a network node 110b, a network node 110c, and a network node 110d), a user equipment (UE) 120 or multiple UEs 120 (shown as a UE 120a, a UE 120b, a UE 120c, a UE 120d, and a UE 120c), or other entities. A network node 110 is an example of a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single RAN node (for example, within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (for example, in 4G), a gNB (for example, in 5G), an access point, or a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 or a network node subsystem serving this coverage area, depending on the context in which the term is used. A network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (for example, three) cells. In some examples, a cell may not necessarily be stationary, and the geographic area of the cell may move according to the location of a network node 110 that is mobile (for example, a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (for example, a network node 110 or a UE 120) and send a transmission of the data to a downstream node (for example, a UE 120 or a network node 110). A relay station may be a UE 120 that can relay transmissions for other UEs 120. In the example shown in FIG. 1, the network node 110d (for example, a relay network node) may communicate with the network node 110a (for example, a macro network node) and the UE 120d in order to facilitate communication between the network node 110a and the UE 120d. A network node 110 that relays communications may be referred to as a relay station, a relay base station, a relay network node, a relay node, or a relay, among other examples.

The wireless network 100 may be a heterogeneous network that includes network nodes 110 of different types, such as macro network nodes, pico network nodes, femto network nodes, or relay network nodes. These different types of network nodes 110 may have different transmit power levels, different coverage areas, or different impacts on interference in the wireless network 100. For example, macro network nodes may have a high transmit power level (for example, 5 to 40 watts) whereas pico network nodes, femto network nodes, and relay network nodes may have lower transmit power levels (for example, 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, or a subscriber unit. A UE 120 may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, smart jewelry (for example, a smart ring or a smart bracelet)), an entertainment device (for example, a music device, a video device, or a satellite radio), a vehicular component or sensor, a smart meter/sensor, industrial manufacturing equipment, a global positioning system device, a UE function of a network node, or any other suitable device that is configured to communicate via a wireless or wired medium.

Some UEs 120 may be considered machine-type communication (MTC) or evolved or enhanced machine-type communication (eMTC) UEs. An MTC UE or an eMTC UE may include, for example, a robot, an unmanned aerial vehicle, a remote device, a sensor, a meter, a monitor, or a location tag, that may communicate with a network node, another device (for example, a remote device), or some other entity. Some UEs 120 may be considered Internet-of-Things (IoT) devices, or may be implemented as NB-IoT (narrowband IoT) devices. Some UEs 120 may be considered a Customer Premises Equipment. A UE 120 may be included inside a housing that houses components of the UE 120, such as processor components or memory components. In some examples, the processor components and the memory components may be coupled together. For example, the processor components (for example, one or more processors) and the memory components (for example, a memory) may be operatively coupled, communicatively coupled, electronically coupled, or electrically coupled.

In general, any number of wireless networks 100 may be deployed in a given geographic area. Each wireless network 100 may support a particular RAT and may operate on one or more frequencies. A RAT may be referred to as a radio technology or an air interface. A frequency may be referred to as a carrier or a frequency channel. Each frequency may support a single RAT in a given geographic area in order to avoid interference between wireless networks of different RATs. In some cases, NR or 5G RAT networks may be deployed.

In some examples, two or more UEs 120 (for example, shown as UE 120a and UE 120c) may communicate directly using one or more sidelink channels (for example, without using a network node 110 as an intermediary to communicate with one another). For example, the UEs 120 may communicate using peer-to-peer (P2P) communications, device-to-device (D2D) communications, a vehicle-to-everything (V2X) protocol (for example, which may include a vehicle-to-vehicle (V2V) protocol, a vehicle-to-infrastructure (V2I) protocol, or a vehicle-to-pedestrian (V2P) protocol), or a mesh network. In such examples, a UE 120 may perform scheduling operations, resource selection operations, or other operations described elsewhere herein as being performed by the network node 110.

Devices of the wireless network 100 may communicate using the electromagnetic spectrum, which may be subdivided by frequency or wavelength into various classes, bands, or channels. For example, devices of the wireless network 100 may communicate using one or more operating bands. In 5G NR, two initial operating bands have been identified as frequency range designations FR1 (410 MHZ-7.125 GHz) and FR2 (24.25 GHZ-52.6 GHZ). Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics or FR2 characteristics, and thus may effectively extend features of FR1 or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHZ-71 GHZ), FR4 (52.6 GHz-114.25 GHZ), and FR5 (114.25 GHZ-300 GHz). Each of these higher frequency bands falls within the EHF band.

With these examples in mind, unless specifically stated otherwise, the term “sub-6 GHz,” if used herein, may broadly represent frequencies that may be less than 6 GHz, may be within FR1, or may include mid-band frequencies. Further, unless specifically stated otherwise, the term “millimeter wave,” if used herein, may broadly represent frequencies that may include mid-band frequencies, may be within FR2, FR4, FR4-a or FR4-1, or FR5, or may be within the EHF band. It is contemplated that the frequencies included in these operating bands (for example, FR1, FR2, FR3, FR4, FR4-a, FR4-1, or FR5) may be modified, and techniques described herein are applicable to those modified frequency ranges.

In some aspects, a first UE (e.g., UE 120a) may include a communication manager 140. As described in more detail elsewhere herein, the communication manager 140 may transmit, to a second UE, an IBP-RS based at least in part on a destination ID, wherein one or more of an IBP-RS sequence, an IBP-RS configuration, or an IBP-RS resource is based at least in part on the destination ID; and receive, from the second UE and based at least in part on the IBP-RS, a beam-pairing response signal for a beam association. Additionally, or alternatively, the communication manager 140 may perform one or more other operations described herein.

In some aspects, a second UE (e.g., UE 120c) may include a communication manager 150. As described in more detail elsewhere herein, the communication manager 150 may receive, from a first UE, an IBP-RS based at least in part on a destination ID, wherein one or more of an IBP-RS sequence, an IBP-RS configuration, or an IBP-RS resource is based at least in part on the destination ID; and transmit, to the first UE and based at least in part on the IBP-RS, a beam-pairing response signal for a beam association. Additionally, or alternatively, the communication manager 150 may perform one or more other operations described herein.

As indicated above, FIG. 1 is provided as an example. Other examples may differ from what is described with regard to FIG. 1.

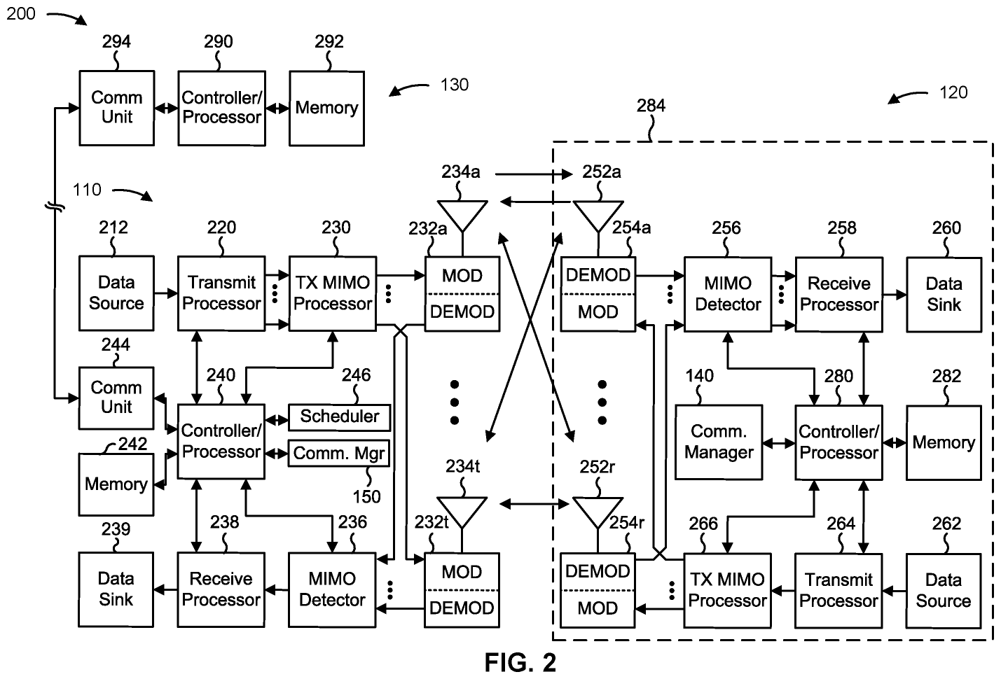

FIG. 2 is a diagram illustrating an example 200 of a network node 110 in communication with a UE 120 in a wireless network 100. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 using one or more channel quality indicators (CQIs) received from that UE 120. The network node 110 may process (for example, encode and modulate) the data for the UE 120 using the MCS(s) selected for the UE 120 and may provide data symbols for the UE 120. The transmit processor 220 may process system information (for example, for semi-static resource partitioning information (SRPI)) and control information (for example, CQI requests, grants, or upper layer signaling) and provide overhead symbols and control symbols. The transmit processor 220 may generate reference symbols for reference signals (for example, a cell-specific reference signal (CRS) or a demodulation reference signal (DMRS)) and synchronization signals (for example, a primary synchronization signal (PSS) or a secondary synchronization signal (SSS)). A Tx multiple-input multiple-output (MIMO) processor 230 may perform spatial processing (for example, precoding) on the data symbols, the control symbols, the overhead symbols, or the reference symbols, if applicable, and may provide a set of output symbol streams (for example, T output symbol streams) to a corresponding set of modems 232 (for example, T modems), shown as modems 232a through 232t. For example, each output symbol stream may be provided to a modulator component (shown as MOD) of a modem 232. Each modem 232 may use a respective modulator component to process a respective output symbol stream (for example, for OFDM) to obtain an output sample stream. Each modem 232 may further use a respective modulator component to process (for example, convert to analog, amplify, filter, or upconvert) the output sample stream to obtain a downlink signal. The modems 232a through 232t may transmit a set of downlink signals (for example, T downlink signals) via a corresponding set of antennas 234 (for example, T antennas), shown as antennas 234a through 234t.

At the UE 120, a set of antennas 252 (shown as antennas 252a through 252r) may receive the downlink signals from the network node 110 or other network nodes 110 and may provide a set of received signals (for example, R received signals) to a set of modems 254 (for example, R modems), shown as modems 254a through 254r. For example, each received signal may be provided to a demodulator component (shown as DEMOD) of a modem 254. Each modem 254 may use a respective demodulator component to condition (for example, filter, amplify, downconvert, or digitize) a received signal to obtain input samples. Each modem 254 may use a demodulator component to further process the input samples (for example, for OFDM) to obtain received symbols. A MIMO detector 256 may obtain received symbols from the modems 254, may perform MIMO detection on the received symbols if applicable, and may provide detected symbols. A receive processor 258 may process (for example, demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (for example, antennas 234a through 234t or antennas 252a through 252r) may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled to one or more transmission or reception components, such as one or more components of FIG. 2.

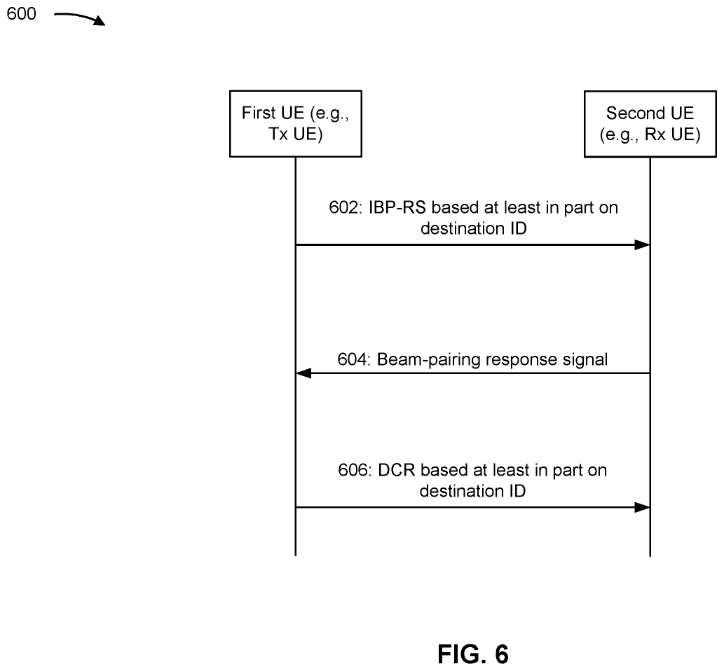

On the uplink, at the UE 120, a transmit processor 264 may receive and process data from a data source 262 and control information (for example, for reports that include RSRP, RSSI, RSRQ, or CQI) from the controller/processor 280. The transmit processor 264 may generate reference symbols for one or more reference signals. The symbols from the transmit processor 264 may be precoded by a Tx MIMO processor 266 if applicable, further processed by the modems 254 (for example, for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, or the Tx MIMO processor 266. The transceiver may be used by a processor (for example, the controller/processor 280) and the memory 282 to perform aspects of any of the processes described herein (e.g., with reference to FIGS. 6-10).

At the network node 110, the uplink signals from UE 120 or other UEs may be received by the antennas 234, processed by the modem 232 (for example, a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, or the Tx MIMO processor 230. The transceiver may be used by a processor (for example, the controller/processor 240) and the memory 242 to perform aspects of any of the processes described herein (e.g., with reference to FIGS. 6-10).

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

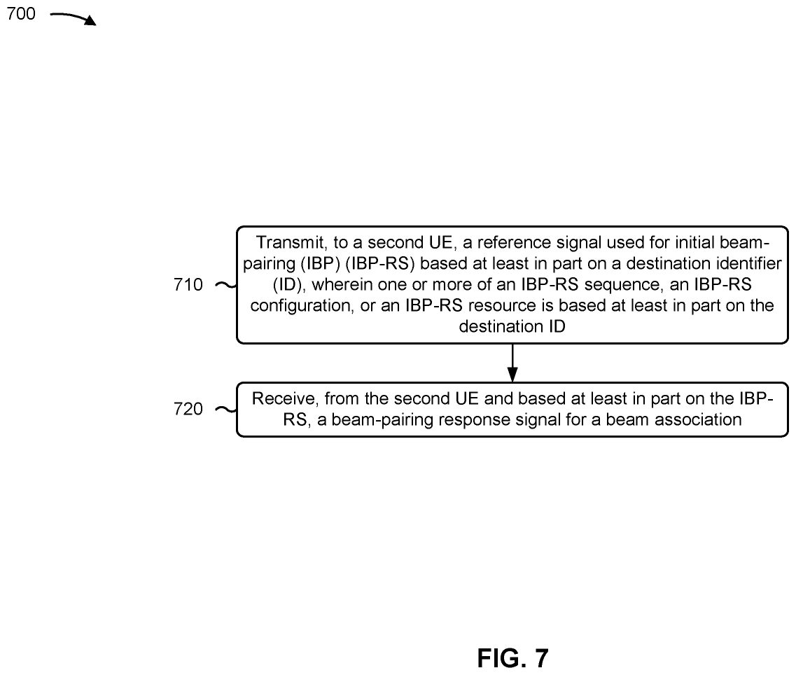

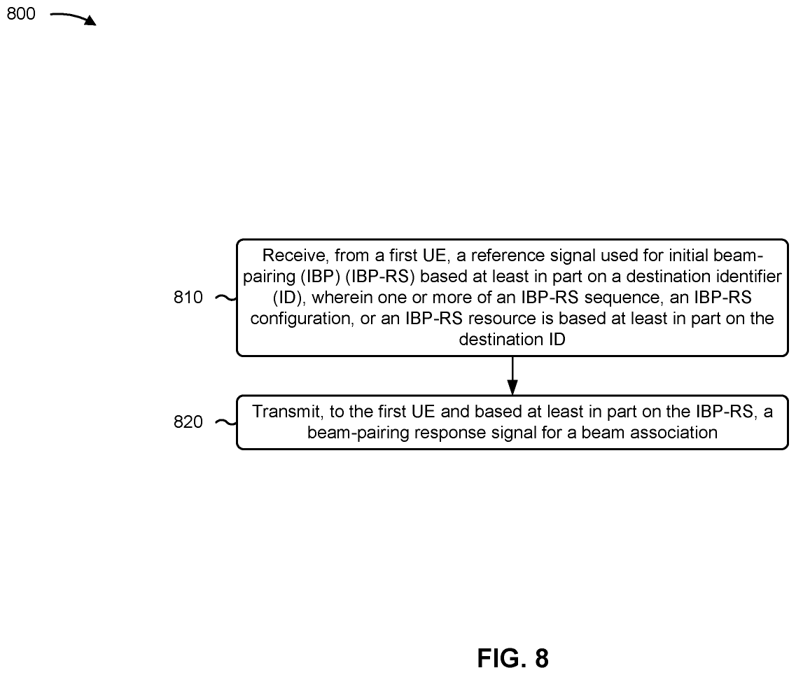

The controller/processor 240 of the network node 110, the controller/processor 280 of the UE 120, or any other component(s) of FIG. 2 may perform one or more techniques associated with IBP-RSs using destination IDs, as described in more detail elsewhere herein. For example, the controller/processor 240 of the network node 110, the controller/processor 280 of the UE 120, or any other component(s) (or combinations of components) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and the memory 282 may include a non-transitory computer-readable medium storing one or more instructions (for example, code or program code) for wireless communication. For example, the one or more instructions, when executed (for example, directly, or after compiling, converting, or interpreting) by one or more processors of the network node 110 or the UE 120, may cause the one or more processors, the UE 120, or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, a first UE (e.g., UE 120a) includes means for transmitting, to a second UE, an IBP-RS based at least in part on a destination ID, wherein one or more of an IBP-RS sequence, an IBP-RS configuration, or an IBP-RS resource is based at least in part on the destination ID; and/or means for receiving, from the second UE and based at least in part on the IBP-RS, a beam-pairing response signal for a beam association. The means for the first UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a second UE (e.g., UE 120c) includes means for receiving, from a first UE, an IBP-RS based at least in part on a destination ID, wherein one or more of an IBP-RS sequence, an IBP-RS configuration, or an IBP-RS resource is based at least in part on the destination ID; and/or means for transmitting, to the first UE and based at least in part on the IBP-RS, a beam-pairing response signal for a beam association. The means for the second UE to perform operations described herein may include, for example, one or more of communication manager 150, antenna 252, modem 254, MIMO detector 256, receive processor 258, transmit processor 264, TX MIMO processor 266, controller/processor 280, or memory 282.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the Tx MIMO processor 266 may be performed by or under the control of the controller/processor 280.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (for example, within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

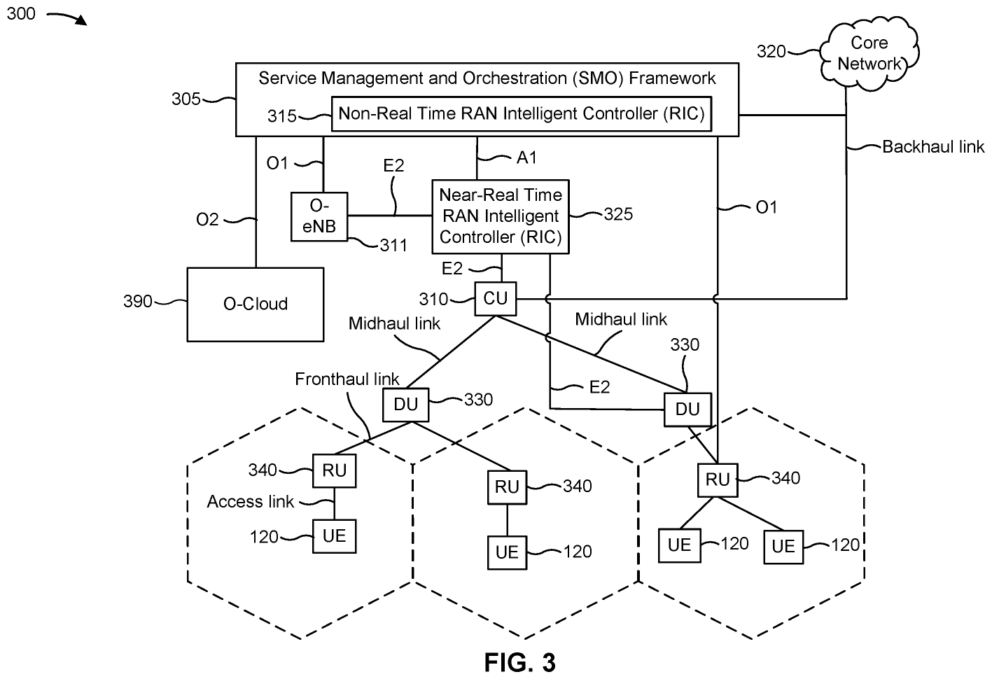

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as a RF transceiver), configured to receive or transmit signals, or both, over a wireless transmission medium to one or more of the other units.

In some aspects, the CU 310 may host one or more higher layer control functions. Such control functions can include RRC functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (IFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

Sidelink unicast communications in an FR2 licensed spectrum may be based at least in part on a sidelink beam management. The sidelink beam management may include an IBP, beam maintenance, and/or beam failure recovery by reusing an existing sidelink channel state information (CSI) framework and by reusing certain Uu beam management designs.

An IBP may be performed before a sidelink unicast link establishment. A first UE may transmit reference signals via different Tx beams. Multiple reference signal transmissions (e.g., repetitions) may be associated with each beam. A second UE may measure the reference signals, and based at least in part on reference signal measurements, the second UE may determine a first UE Tx beam and/or a second UE Rx beam. In some cases, the second UE may determine a second UE Tx beam. The second UE may indicate, to the first UE, a determined first UE Tx beam. The first UE and the second UE may set up the sidelink unicast link using the determined first UE Tx beam based at least in part on an existing link establishment procedure.

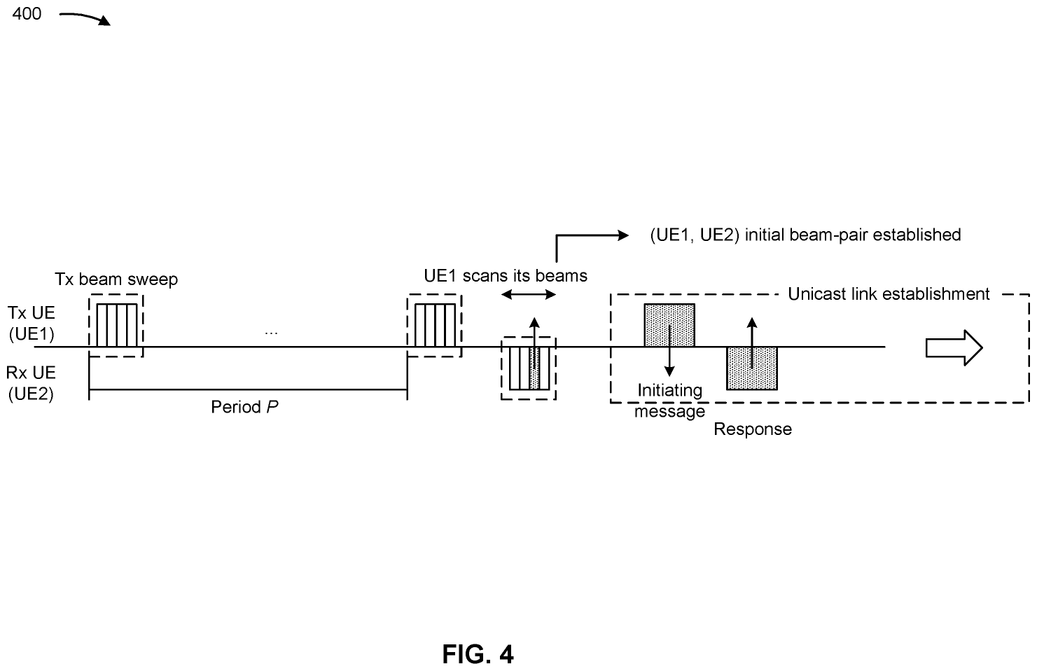

FIG. 4 is a diagram illustrating an example 400 of establishing an IBP, in accordance with the present disclosure.

As shown in FIG. 4, a first UE (e.g., a Tx UE) may transmit a plurality of reference signals via different Tx beams, which may be based at least in part on a Tx beam sweep. The first UE may repeat the Tx beam sweep after a period P. A second UE may measure the plurality of reference signals. The second UE may determine a first UE Tx beam and/or a second UE Rx beam, which may be based at least in part on measurements of the plurality of reference signals. The second UE may transmit, to the first UE, an indication of a determined first UE Tx beam and/or a determined second UE Rx beam. The first UE may establish an IBP for the first UE and the second UE based at least in part on the indication. During a unicast link establishment, the first UE may transmit an initiating message to the second UE, and the second UE may transmit a response to the first UE, where the initiating message and the response may be based at least in part on the IBP.

As indicated above, FIG. 4 is provided as an example. Other examples may differ from what is described with regard to FIG. 4.

During a unicast link establishment procedure, a second UE (e.g., an Rx UE) may determine a destination layer-2 ID for a reception of a message for sidelink communication establishment carried by a physical sidelink shared channel (PSSCH) and a corresponding physical sidelink control channel (PSCCH), where the message may be a direct communication request (DCR) message. A first UE (e.g., a Tx UE) may determine the destination layer-2 ID for a transmission of the DCR message. The first UE may self-assign a source layer-2 ID for the DCR message. For a response to the DCR message (e.g., a security establishment message), the second UE may set the destination layer-2 ID to the source layer-2 ID of a received DCR message. The first UE may obtain the second UE's layer-2 ID for subsequent communication with the second UE.

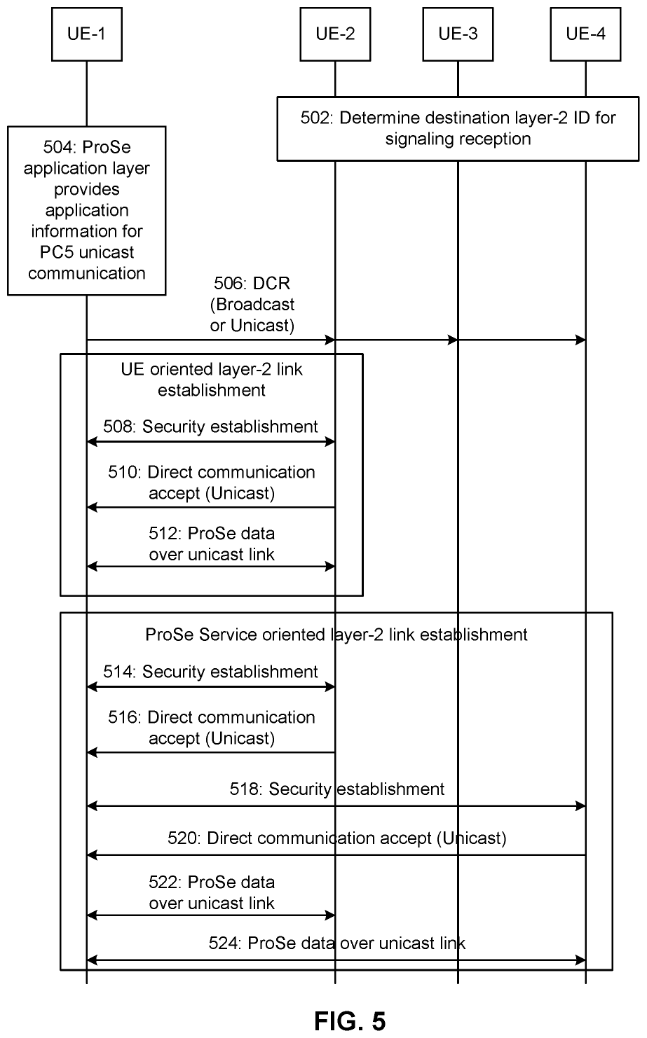

FIG. 5 is a diagram illustrating an example 500 of a unicast link establishment procedure, in accordance with the present disclosure. As shown in FIG. 5, example 500 includes communication between a first UE (UE-1), a second UE (UE-2), a third UE (UE-3), and a fourth UE (UE-4). In some aspects, the first UE, the second UE, the third UE, and the fourth UE may be included in a wireless network, such as wireless network 100.

As shown by reference number 502, the second UE, the third UE, and the fourth UE may determine a destination layer-2 ID for signaling reception, respectively. As shown by reference number 504, the first UE may provide, via a proximity services (ProSc) application layer, application information for a PC5 unicast communication. As shown by reference number 506, the first UE may transmit a DCR message to the second UE, the third UE, and the fourth UE, respectively. The first UE may transmit the DCR message via a broadcast or a unicast.

During a UE oriented layer-2 link establishment, as shown by reference number 508, the first UE and the second UE may perform a security establishment. As shown by reference number 510, the first UE may receive, from the second UE, a direct communication accept message via a unicast. As shown by reference number 512, the first UE and the second UE may establish a ProSe data over unicast link.

During a ProSe service oriented layer-2 link establishment, as shown by reference number 514, the first UE and the second UE may perform a security establishment. As shown by reference number 516, the first UE may receive, from the second UE, a direct communication accept message via a unicast. As shown by reference number 518, the first UE and the fourth UE may perform a security establishment. As shown by reference number 520, the first UE may receive, from the fourth UE, a direct communication accept message via a unicast. As shown by reference number 522, the first UE and the second UE may establish a ProSe data over unicast link. As shown by reference number 524, the first UE and the fourth UE may establish a ProSe data over unicast link.

As indicated above, FIG. 5 is provided as an example. Other examples may differ from what is described with regard to FIG. 5.

During a unicast link establishment procedure, a destination ID of a DCR may be set to a layer-2 ID of a second UE (e.g., a target second UE), when the layer-2 ID of the target second UE is known to a first UE (e.g., a Tx UE). When the first UE does not know the layer-2 ID of the second UE, the destination ID of the message may be set to a service ID (e.g., a ProSe service ID). The second UE may receive and decode the DCR. The second UE may check whether the destination ID of the DCR matches to a service ID of interest to the second UE. When the destination ID does not match to any service IDs of interest to the second UE, the second UE may not respond to the first UE. When the destination ID matches to one of the service IDs of interest to the second UE, the second UE may transmit a response message to the first UE. The destination ID of the response message may be set to a layer-2 ID of the first UE, and a source ID of the response message may be set to a layer-2 ID of the second UE. The first UE may identify the layer-2 ID of the responding second UE based at least in part on the destination ID of the response message. After the response message is transmitted to the first UE, an IBP may be established between the first UE and the second UE.

A ProSe direct communication may be associated with various ID(s), such as a destination layer-2 ID and a source layer-2 ID. For a broadcast ProSe direct communication, the destination layer-2 ID may be mapped from a ProSe service (e.g., a ProSe ID). For a groupcast ProSe direct communication, when an application layer group ID is provided, a ProSe layer-2 group ID may be used, if provided, or otherwise the application layer group ID may be converted. When the application layer group ID is not provided, the destination layer-2 ID may be based at least in part on a mapping between a ProSe ID and a layer-2 ID. For a unicast ProSe direct communication, a peer application layer ID may be discovered during a unicast link establishment, known already, or obtained from a ProSe direct discovery process. A default destination layer-2 ID may be associated with the ProSe service (e.g., the ProSe ID). The default destination layer-2 ID may be for an initial signal for the unicast link establishment when a peer layer-2 ID is not known. The source layer-2 ID may be self-assigned, and may be changed based at least in part on a privacy timer.

In a broadcast procedure for a ProSe direct communication, the second UE may determine a destination layer-2 ID for a reception, as well as PC5 quality of service (QoS) parameters and an NR Tx profile. The first UE may determine the destination layer-2 ID for a transmission, as well as the PC5 QoS parameters and the NR Tx profile. The first UE, via a ProSe application layer, may provide a data unit and optional QoS requirements to a ProSe layer. The first UE may self-assign a source layer-2 ID. The first UE, via a ProSe service, may perform a broadcast transmission.

In a groupcast for a ProSe direct communication, a group management may be carried out in a ProSe application layer, which may be associated with the first UE and second UE(s). The first UE and the second UE(s) may perform a ProSe group member discovery to exchange an application layer group ID. The ProSe application layer may provide group identifier information. The second UE(s) may determine a destination layer-2 ID for a reception, as well as PC5 QoS parameters and an NR Tx profile. The first UE may determine source and destination layer-2 IDs for a transmission, as well as the PC5 QoS parameters and the NR Tx profile. The first UE may self-assign a source layer-2 ID. The first UE may transmit ProSe data via a groupcast transmission.

A ProSe direct discovery may be associated with various ID(s), such as the destination layer-2 ID and the source layer-2 ID. For a Model A and a Model B solicitation message, a mapping of ProSe services (e.g., ProSe IDs) to destination layer-2 ID(s) for Tx/Rx initial signaling of discovery messages may be provisioned by each UE. Destination layer-2 ID(s) may be different between ProSe direct discovery, ProSc direct communication, and ProSe UE-to-network (U2N) relay discovery. For a group member discovery, when the application layer group ID is provided, the ProSe layer-2 group ID may be used, if provided, or otherwise the application layer group ID may be converted. When the application layer group ID is not provided, the destination layer-2 ID may be based at least in part on the mapping between the ProSe ID and the layer-2 ID. The source layer-2 ID may be self-assigned. The source layer-2 ID may be different from a source layer-2 ID for ProSe direct communication. The source layer-2 ID may be different from any other provisioned destination layer-2 ID. The source layer-2 ID may be different from any other self-selected source layer-2 IDs used in direct discovery with a different discovery model.

In a Model A ProSe direct discovery, an announcing UE may determine a destination layer-2 ID and a source layer-2 ID for an announcement message. A second UE may determine the destination layer-2 ID for reception. In a Mode B ProSe direct discovery, a discoverer UE may determine a destination layer-2 ID and a source layer-2 ID for a solicitation message. A discoveree UE may determine the destination layer-2 ID for reception. The discoveree UE that matches the solicitation message may respond to the discoverer UE using the source layer-2 ID and the destination layer-2 ID, where the source layer-2 ID may be self-selected and the destination layer-2 ID may be set to the source layer-2 ID of the received solicitation message.

As previously described (e.g., in connection with FIG. 4), an IBP may be performed before a sidelink unicast link establishment. A first UE may transmit reference signals via different Tx beams. A second UE may measure the reference signals, and based at least in part on reference signal measurements, the second UE may determine a first UE Tx beam and/or a second UE Rx beam. In some cases, the second UE may determine a second UE Tx beam. The second UE may indicate, to the first UE, a determined first UE Tx beam. The first UE and the second UE may set up the sidelink unicast link using the determined first UE Tx beam based at least in part on an existing link establishment procedure.

In some cases, a first UE may perform an unnecessary IBP with irrelevant second UEs. The first UE may transmit the reference signals for IBP. The irrelevant second UEs, which may be around the first UE, may receive the reference signals from the first UE. The irrelevant second UEs may respond to the first UE to establish initial beam pairs. At a later time, during the unicast link establishment, the first UE may determine that the second UEs are irrelevant, which may cause a unicast link to not be established. However, performing (at least partially) unnecessary unicast link establishment procedures due to the irrelevant second UEs responding to the first UE may unnecessarily consume UE energy and radio resources, thereby degrading a performance of the first UE and/or the irrelevant second UEs.

In various aspects of techniques and apparatuses described herein, a first UE (e.g., a Tx UE) may determine an IBP-RS based at least in part on a destination ID. The IBP-RS may be a reference signal used for IBP, which may include a channel or a payload associated with the reference signal. The destination ID may be a layer-2 ID of a second UE (e.g., an Rx UE) when the second UE is a target second UE. The destination ID may be a service ID, which may be associated with a ProSe service ID. The first UE may determine an IBP-RS sequence, an IBP-RS configuration, and/or an IBP-RS resource based at least in part on the destination ID. A level of uniqueness may be ensured for the IBP-RS, even before a start of a unicast link establishment procedure. For example, ID(s) or higher layer parameter(s) that are known by the first UE and the second UE may be used to derive the IBP-RS sequence, the IBP-RS configuration, and/or the IBP-RS resource, which may be aimed at filtering out irrelevant second UEs' processes. The first UE may transmit, to the second UE, the IBP-RS based at least in part on the destination ID. In some aspects, when the destination ID is the layer-2 ID of the second UE, an IBP process between the first UE and a non-target second UE may be avoided. When the destination ID is the service ID, an IBP process between the first UE and a second UE having no interest in a service associated with the service ID may be avoided. As a result, irrelevant second UEs (e.g., non-target second UEs) may not respond to the first UE based at least in part on the IBP-RS. The irrelevant second UEs may not respond to the first UE for the purpose of establishing IBPs, which may reduce a UE energy consumption and radio resources for both the first UE and the second UE.

FIG. 6 is a diagram illustrating an example 600 associated with IBP-RSs using destination IDs, in accordance with the present disclosure. As shown in FIG. 6, example 600 includes communication between a first UE (e.g., UE 120a) and a second UE (e.g., UE 120c). In some aspects, the first UE and the second UE may be included in a wireless network, such as wireless network 100. The first UE may be a Tx UE and the second UE may be an Rx UE.

As shown by reference number 602, the first UE may transmit, to the second UE, an IBP-RS based at least in part on a destination ID. The destination ID may be a 24-bit length ID, which may be associated with a destination of a sidelink message. An IBP-RS sequence, an IBP-RS configuration, and/or an IBP-RS resource may be based at least in part on the destination ID. In other words, the first UE may determine or derive the IBP-RS sequence, the IBP-RS configuration, and/or the IBP-RS resource using the destination ID. The destination ID may be a layer-2 ID of the second UE when the second UE is a target UE. Alternatively, the destination ID may be a service ID associated with a ProSe service ID or a V2V service ID. In some aspects, when the destination ID is the layer-2 ID of the second UE, an IBP process between the first UE and a non-target UE may be avoided. When the destination ID is the service ID, an IBP process between the first UE and a UE having no interest in a service associated with the service ID may be avoided.

In some aspects, the first UE may generate the IBP-RS using the IBP-RS sequence. The IBP-RS sequence may be a sequence (e.g., a Gold sequence or a Zadoff-Chu sequence) that is derived using the destination ID. The first UE may generate the IBP-RS using the IBP-RS configuration. The IBP-RS configuration may be a configuration that is derived using the destination ID. The IBP-RS configuration may include one or more parameters, which may be set in accordance with the destination ID. The first UE may transmit the IBP-RS using the IBP-RS resource. The IBP-RS may be a time and/or frequency resource used to transmit the IBP-RS. The IBP-RS resource may be selected or allocated based at least in part on the destination ID. Different IBP-RS resources may be associated with different destination IDs.

In some aspects, the destination ID may be used for the IBP-RS. The destination ID (e.g., a layer-2 destination ID) may indicate a destination of a message (e.g., a sidelink message). The destination ID may be associated with a 24-bit length. A 16-bit least significant bit (LSB) may be indicated in a sidelink control information (SCI) format 2, and a remaining 8 bits may be indicated in a MAC sub-header or control element (CE) of the message.

In some aspects, for the IBP-RS before a unicast link establishment, the destination ID may be used to ensure some uniqueness of the IBP-RS, where the destination ID may be used in a DCR message for a subsequent existing unicast link establishment. For example, a first IBP-RS associated with a first destination ID may be different from a second IBP-RS associated with a second destination ID. When the first destination ID is different from the second destination ID, the first IBP-RS may be unique from the second IBP-RS. The first UE may use the destination ID for determining the IBP-RS sequence, the IBP-RS configuration, and/or the IBP-RS resource. The second UE may monitor the IBP-RS with the IBP-RS sequence(s), IBP-RS configuration(s), and/or IBP-RS resource(s) derived from the destination ID(s) that the second UE may use for a DCR message reception.

In some aspects, when the destination ID used for IBP-RS is the layer-2 ID of the second UE (e.g., a target UE), the IBP process by non-target second UEs may be avoided. When the destination ID used for IBP-RS is the service ID, the IBP process by UEs (e.g., non-target UEs) that have no interest in the service having the service ID may be avoided. When a monotonic service is operated by a plurality of UEs on the same frequency, IBP by irrelevant UEs may occur. However, since a service provider may select any ID from 224 IDs, the issue may generally be avoided.

In some aspects, when an IBP-RS is associated with a destination ID that is not associated with the second UE or is associated with a service that is not of interest to the second UE, the second UE may not detect the IBP-RS. As a result, the second UE may not mistakenly respond to the first UE and unnecessarily initiate the unicast link establishment, thereby reducing signaling and a resource utilization for both the first UE and the second UE. When the IBP-RS is not unique based at least in part on the destination ID, the second UE may respond to the first UE, even when the unicast link establishment between the first UE and the second UE is not needed.

In some aspects, a scrambling ID or a sequence ID (scrambling/sequence ID) of the IBP-RS may be based at least in part on the destination ID. The scrambling/sequence ID may be a sequence of bits (e.g., a pseudo random sequence of bits) used for scrambling, which may be derived using the destination ID. The scrambling/sequence ID may be based at least in part on a decimal representation of the destination ID. The scrambling/sequence ID may be based at least in part on a cyclic redundancy check (CRC) of sidelink control information (SCI) associated with the IBP-RS and the destination ID. The scrambling/sequence ID may be based at least in part on a concatenation of a defined quantity of bits of a CRC of SCI associated with the IBP-RS, and a defined quantity of bits of the destination ID.

In some aspects, the destination ID may be used to derive the scrambling ID (n_{ID}) or the sequence ID of the IBP-RS. As an example, the IBP-RS may be a sidelink channel state information reference signal (CSI-RS). A pseudo-random sequence generator may be initialized with: cᵢₙᵢₜ=(2¹⁰ (N_{symb}^{slot} n_{s,f}^{μ}+l+1)(2n_{ID}+1)+n_{ID}) mod 2³¹, where cᵢₙᵢₜ is a seed value, N_{symb}^{slot} is a number of symbols per slot, n_{s,f}^{μ} is a slot number within a frame for subcarrier spacing configuration μ, l is the OFDM symbol number within a slot, and n_{ID}=N_{ID}^{X} mod 2¹⁰, where the quantity Nip equals the decimal representation of a CRC for SCI mapped to a PSCCH associated with a CSI-RS.

In some aspects, the scrambling ID of the IBP-RS may be derived from the destination ID. In a first option, the representation of the destination ID may be set to NID, which may be instead of an existing 24-bit CRC of an SCI mapped to a PSCCH associated with a sidelink CSI-RS. The decimal representation may be of a 24-bit destination ID, or a 16-bit LSBs of the destination ID. In a second option, a logical AND between the CRC of the SCI associated with the IBP-RS and the destination ID may be set to n_{ID} (e.g., 24-bit and 24-bit, or 16 LSB bits and 16 LSB bits). In a third option, X LSB bits or X most significant bit (MSB) bits of the CRC of the SCI, and Y LSB/MSB bits of the destination ID may be concatenated to form a (X+Y)-bit length ID (e.g., X+Y≤32), which may be set to n_{ID}.

In some aspects, the scrambling/sequence ID of the IBP-RS may be based at least in part on a Z-bit random factor. The destination ID may be associated with a Z-bit random factor, and the scrambling/sequence ID of the IBP-RS, the IBP-RS configuration, and/or the IBP-RS resource may be based at least in part on the destination ID associated with the Z-bit random factor. The scrambling/sequence ID of the IBP-RS, the IBP-RS configuration, and/or the IBP-RS resource may be based at least in part on a source ID of the first UE and the destination ID, and the source ID may be mapped to a service ID.

In some aspects, in addition to the destination ID, the first UE may be allowed to select a random Z-bit input to derive the scrambling/sequence ID of the IBP-RS. For example, when multiple first UEs do not have particular layer-2 IDs of target second UEs, but have the same service ID, the same scrambling/sequence ID for IBP-RS from the multiple first UEs may be used. The second UE may observe a combined IBP-RS from the multiple first UEs. The Z-bit random factor may be used to determine the scrambling/sequence ID at the first UE. Different first UEs may select different values from the random factor, in which case the second UE may observe the IBP-RS from different first UEs separately. The second UE may monitor the IBP-RS with the scrambling/sequence IDs derived from the destination ID(s) and the Z-bit random factor. A blind search may be necessary at the second UE for 22 hypotheses.

In some aspects, the destination ID (potentially with a random factor) may be used to determine an IBP-RS configuration/resource, in addition to, or instead of, being used to determine an IBP-RS scrambling/sequence ID.

In some aspects, the source ID of the first UE, as well as the destination ID, may be used to determine the IBP-RS scrambling/sequence ID or the IBP-RS configuration/resource. The first UE may determine the source ID by itself. The mapping may be specified between the service ID and the source ID. The mapping may be a one-to-one mapping, a one-to-multiple mapping, a multiple-to-one mapping, or a multiple-to-multiple mapping. When the destination ID is the service ID (e.g., the first UE does not know a particular target second UE), the destination ID may not be fully unique. At least the first UEs for the same service may use the same destination ID. However, those first UEs may select different source IDs. By using both the source ID and the destination ID to determine an IBP-RS configuration, a loss of uniqueness may be avoided with a higher probability. The second UE may monitor the IBP-RS with multiple source ID hypotheses, such that a quantity of candidate source IDs that are mapped to a particular service ID should be limited (e.g., the quantity of candidate source IDs cannot be greater than a threshold value).

As shown by reference number 604, the first UE may receive, from the second UE and based at least in part on the IBP-RS, a beam-pairing response (BPR) signal for a beam association. The BPR signal may be associated with a physical sidelink feedback channel (PSFCH), a sidelink channel state information reference signal (SL CSI-RS), a sidelink synchronization signal block (S-SSB), a physical sidelink control channel (PSCCH), or the IBP-RS. A resource or a sequence associated with the BPR signal may be independent of the destination ID of the second UE. The resource or the sequence associated with the BPR signal may be based at least in part on a resource ID of the IBP-RS or the scrambling/sequence ID of the IBP-RS.

In some aspects, the second UE may monitor and/or search for the IBP-RS using its provisioned destination ID(s), which may include ProSe service ID(s) and/or its own layer-2 ID. The second UE may monitor or search for the IBP-RS based at least in part on the destination ID provisioned for the second UE. The second UE may not receive or detect IBP-RS that are derived from destination IDs that are not associated with the second UE, which may prevent the second UE from unnecessarily responding to the first UE. A second UE having multiple interests may be required to monitor/search for multiple IBP-RS sequences. The second UE may respond to the first UE using a resource for the BPR signal for beam association. The resource/sequence of the BPR signal from the second UE may not depend on the layer-2 ID of the second UE. The BPR signal may be single frequency networked from multiple second UEs to the first UE sharing the same first UE's Tx beam. When the BPR signal is re-used as a beam failure recovery request of a sidelink beam failure recovery, the BPR signal may depend on the layer-2 ID of the second UE. The resource/sequence of the BPR signal may depend on the resource/scrambling ID of the IBP-RS. As a result, confusion from BPR signals from multiple second UEs at different first UEs may be avoided. Further, when the BPR signal is associated with a PSFCH, elements of the BPR signal may be derived from those of the IBP-RS.

In some aspects, the IBP-RS, which may be based at least in part on the destination ID, may be associated with a unicast link establishment between the first UE and the second UE. The IBP-RS may be associated with an IBP for sidelink broadcast communication. The IBP-RS may be associated with an IBP for sidelink groupcast communication. The IBP-RS may be associated with an IBP for direct or UE-to-network discovery. The IBP-RS may be associated with an IBP for direct or UE-to-network group discovery.

In some aspects, using the destination ID for the IBP-RS may be targeted to an IBP for a unicast link establishment procedure. However, using the destination ID in such a manner may be extended or applicable to IBP for various scenarios. A first scenario may include an IBP for sidelink broadcast communication, in which case the destination ID used for IBP-RS may be a service ID of a broadcast. A second scenario may include an IBP for sidelink groupcast communication, in which case the destination ID used for IBP-RS may be an L2 group ID of a groupcast when available, and may be a service ID when the L2 group ID is not available. A third scenario may include an IBP for direct or UE-to-network discovery, in which case the destination ID used for IBP-RS may be a service ID of a discovery. A fourth scenario may include an IBP for direct or UE-to-network group discovery, in which case the destination ID used for IBP-RS may be an L2 group ID of a groupcast when available, and may be a service ID when the L2 group ID is not available.

As shown by reference number 606, the first UE may transmit, to the second UE, a DCR based at least in part on the destination ID. The first UE may transmit the DCR after receiving the BPR signal from the second UE. The first UE may transmit the DCR as part of the unicast link establishment. The first UE may receive, from the second UE, a response based at least in part the DCR, which may be part of the unicast link establishment.

As indicated above, FIG. 6 is provided as an example. Other examples may differ from what is described with regard to FIG. 6.

FIG. 7 is a diagram illustrating an example process 700 performed, for example, by a first UE, in accordance with the present disclosure. Example process 700 is an example where the first UE (e.g., UE 120a) performs operations associated with IBP-RSs using destination IDs.

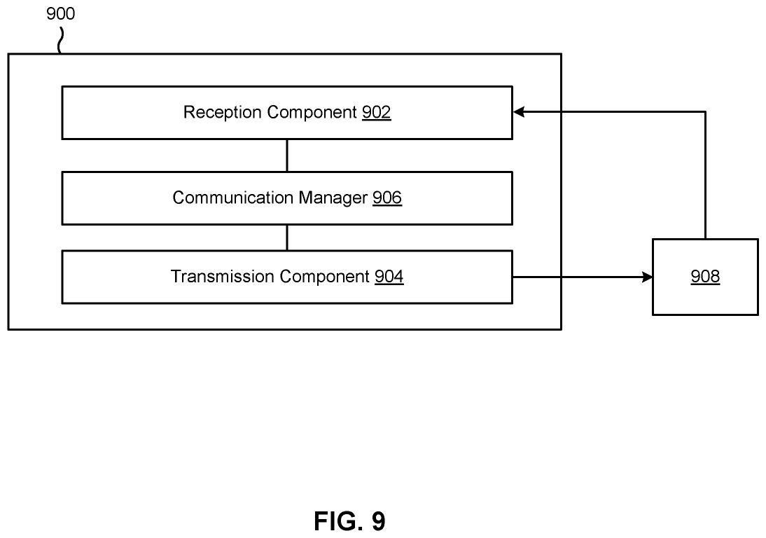

As shown in FIG. 7, in some aspects, process 700 may include transmitting, to a second UE, an IBP-RS based at least in part on a destination ID, wherein one or more of an IBP-RS sequence, an IBP-RS configuration, or an IBP-RS resource is based at least in part on the destination ID (block 710). For example, the first UE (e.g., using transmission component 904 and/or communication manager 906, depicted in FIG. 9) may transmit, to a second UE, an IBP-RS based at least in part on a destination ID, wherein one or more of an IBP-RS sequence, an IBP-RS configuration, or an IBP-RS resource is based at least in part on the destination ID, as described above.

As shown in FIG. 7, in some aspects, process 700 may include receiving, from the second UE and based at least in part on the IBP-RS, a beam-pairing response signal for a beam association (block 720). For example, the first UE (e.g., using reception component 902 and/or communication manager 906, depicted in FIG. 9) may receive, from the second UE and based at least in part on the IBP-RS, a beam-pairing response signal for a beam association, as described above.

Process 700 may include additional aspects, such as any single aspect or any combination of aspects described below and/or in connection with one or more other processes described elsewhere herein.

In a first aspect, process 700 includes transmitting, to the second UE, a DCR based at least in part on the destination ID.

In a second aspect, alone or in combination with the first aspect, the destination ID is a layer-2 ID of the second UE based at least in part on the second UE being a target UE.

In a third aspect, alone or in combination with one or more of the first and second aspects, the destination ID is a service ID associated with a proximity services (ProSe) service ID.

In a fourth aspect, alone or in combination with one or more of the first through third aspects, the destination ID is a service ID associated with a vehicle-to-vehicle (V2V) service ID.

In a fifth aspect, alone or in combination with one or more of the first through fourth aspects, a scrambling or sequence ID of the IBP-RS is based at least in part on the destination ID.

In a sixth aspect, alone or in combination with one or more of the first through fifth aspects, the scrambling or sequence ID is based at least in part on a decimal representation of the destination ID.

In a seventh aspect, alone or in combination with one or more of the first through sixth aspects, the scrambling or sequence ID is based at least in part on a CRC of SCI associated with the IBP-RS and the destination ID.

In an eighth aspect, alone or in combination with one or more of the first through seventh aspects, the scrambling or sequence ID is based at least in part on a concatenation of a defined quantity of bits of a CRC of SCI associated with the IBP-RS, and a defined quantity of bits of the destination ID.

In a ninth aspect, alone or in combination with one or more of the first through eighth aspects, a scrambling or sequence ID of the IBP-RS is based at least in part on a Z-bit random factor.

In a tenth aspect, alone or in combination with one or more of the first through ninth aspects, the destination ID is associated with a Z-bit random factor, and one or more of a scrambling or sequence ID of the IBP-RS, the IBP-RS configuration, or the IBP-RS resource is based at least in part on the destination ID associated with the Z-bit random factor.

In an eleventh aspect, alone or in combination with one or more of the first through tenth aspects, one or more of a scrambling or sequence ID of the IBP-RS, the IBP-RS configuration, or the IBP-RS resource is based at least in part on a source ID of the first UE and the destination ID, and the source ID is mapped to a service ID.

In a twelfth aspect, alone or in combination with one or more of the first through eleventh aspects, the BPR signal is associated with one of a PSFCH, an SL-CSI-RS, an S-SSB, a PSCCH, or the IBP-RS.

In a thirteenth aspect, alone or in combination with one or more of the first through twelfth aspects, a resource or a sequence associated with the beam-pairing response signal is independent of the destination ID of the second UE.

In a fourteenth aspect, alone or in combination with one or more of the first through thirteenth aspects, a resource or a sequence associated with the beam-pairing response signal is based at least in part on a resource ID of the IBP-RS or a scrambling or sequence ID of the IBP-RS.

In a fifteenth aspect, alone or in combination with one or more of the first through fourteenth aspects, the IBP-RS based at least in part on the destination ID is associated with a unicast link establishment between the first UE and the second UE.

In a sixteenth aspect, alone or in combination with one or more of the first through fifteenth aspects, the IBP-RS based at least in part on the destination ID is associated with an IBP for sidelink broadcast communication.

In a seventeenth aspect, alone or in combination with one or more of the first through sixteenth aspects, the IBP-RS based at least in part on the destination ID is associated with an IBP for sidelink groupcast communication.

In an eighteenth aspect, alone or in combination with one or more of the first through seventeenth aspects, the IBP-RS based at least in part on the destination ID is associated with an IBP for direct or UE-to-network discovery.

In a nineteenth aspect, alone or in combination with one or more of the first through eighteenth aspects, the IBP-RS based at least in part on the destination ID is associated with an IBP for direct or UE-to-network group discovery.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a second UE, in accordance with the present disclosure. Example process 800 is an example where the second UE (e.g., UE 120) performs operations associated with IBP-RSs using destination IDs.

As shown in FIG. 8, in some aspects, process 800 may include receiving, from a first UE, an IBP-RS based at least in part on a destination ID, wherein one or more of an IBP-RS sequence, an IBP-RS configuration, or an IBP-RS resource is based at least in part on the destination ID (block 810). For example, the second UE (e.g., using reception component 902 and/or communication manager 906, depicted in FIG. 9) may receive, from a first UE, an IBP-RS based at least in part on a destination ID, wherein one or more of an IBP-RS sequence, an IBP-RS configuration, or an IBP-RS resource is based at least in part on the destination ID, as described above.

As shown in FIG. 8, in some aspects, process 800 may include transmitting, to the first UE and based at least in part on the IBP-RS, a beam-pairing response signal for a beam association (block 820). For example, the second UE (e.g., using transmission component 904 and/or communication manager 906, depicted in FIG. 9) may transmit, to the first UE and based at least in part on the IBP-RS, a beam-pairing response signal for a beam association, as described above.

Process 800 may include additional aspects, such as any single aspect or any combination of aspects described below and/or in connection with one or more other processes described elsewhere herein.

In a first aspect, process 800 includes receiving, from the first UE, a DCR based at least in part on the destination ID.

In a second aspect, alone or in combination with the first aspect, process 800 includes monitoring or searching for the IBP-RS based at least in part on the destination ID provisioned for the second UE.

In a third aspect, alone or in combination with one or more of the first and second aspects, the destination ID is a layer-2 ID of the second UE based at least in part on the second UE being a target UE.

In a fourth aspect, alone or in combination with one or more of the first through third aspects, the destination ID is a service ID associated with a proximity services (ProSe) service ID.

In a fifth aspect, alone or in combination with one or more of the first through fourth aspects, the destination ID is a service ID associated with a vehicle-to-vehicle (V2V) service ID.

In a sixth aspect, alone or in combination with one or more of the first through fifth aspects, a scrambling or sequence ID of the IBP-RS is based at least in part on the destination ID.

In a seventh aspect, alone or in combination with one or more of the first through sixth aspects, the scrambling or sequence ID is based at least in part on a decimal representation of the destination ID.

In an eighth aspect, alone or in combination with one or more of the first through seventh aspects, the scrambling or sequence ID is based at least in part on a CRC of SCI associated with the IBP-RS and the destination ID.

In a ninth aspect, alone or in combination with one or more of the first through eighth aspects, the scrambling or sequence ID is based at least in part on a concatenation of a defined quantity of bits of a CRC of SCI associated with the IBP-RS, and a defined quantity of bits of the destination ID.

In a tenth aspect, alone or in combination with one or more of the first through ninth aspects, a scrambling or sequence ID of the IBP-RS is based at least in part on a Z-bit random factor.

In an eleventh aspect, alone or in combination with one or more of the first through tenth aspects, the destination ID is associated with a Z-bit random factor, and one or more of a scrambling or sequence ID of the IBP-RS, the IBP-RS configuration, or the IBP-RS resource is based at least in part on the destination ID associated with the Z-bit random factor.

In a twelfth aspect, alone or in combination with one or more of the first through eleventh aspects, one or more of a scrambling or sequence ID of the IBP-RS, the IBP-RS configuration, or the IBP-RS resource is based at least in part on a source ID of the first UE and the destination ID, and the source ID is mapped to a service ID.

In a thirteenth aspect, alone or in combination with one or more of the first through twelfth aspects, the beam-pairing response signal is associated with one of a PSFCH, an SL CSI-RS, an S-SSB, a PSCCH, or the IBP-RS.

In a fourteenth aspect, alone or in combination with one or more of the first through thirteenth aspects, a resource or a sequence associated with the beam-pairing response signal is independent of the destination ID of the second UE.

In a fifteenth aspect, alone or in combination with one or more of the first through fourteenth aspects, a resource or a sequence associated with the beam-pairing response signal is based at least in part on a resource ID of the IBP-RS or a scrambling or sequence ID of the IBP-RS.

In a sixteenth aspect, alone or in combination with one or more of the first through fifteenth aspects, the IBP-RS based at least in part on the destination ID is associated with a unicast link establishment between the first UE and the second UE.

In a seventeenth aspect, alone or in combination with one or more of the first through sixteenth aspects, the IBP-RS based at least in part on the destination ID is associated with an IBP for sidelink broadcast communication.

In an eighteenth aspect, alone or in combination with one or more of the first through seventeenth aspects, the IBP-RS based at least in part on the destination ID is associated with an IBP for sidelink groupcast communication.

In a nineteenth aspect, alone or in combination with one or more of the first through eighteenth aspects, the IBP-RS based at least in part on the destination ID is associated with an IBP for direct or UE-to-network discovery.

In a twentieth aspect, alone or in combination with one or more of the first through nineteenth aspects, the IBP-RS based at least in part on the destination ID is associated with an IBP for direct or UE-to-network group discovery.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a first UE, or a first UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIG. 6. Additionally, or alternatively, the apparatus 900 may be configured to perform one or more processes described herein, such as process 700 of FIG. 7. In some aspects, the apparatus 900 and/or one or more components shown in FIG. 9 may include one or more components of the first UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the first UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the first UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit an IBP-RS based at least in part on a destination ID, wherein one or more of an IBP-RS sequence, an IBP-RS configuration, or an IBP-RS resource is based at least in part on the destination ID. The reception component 902 may receive, based at least in part on the IBP-RS, a BPR signal for a beam association. The transmission component 904 may transmit a DCR based at least in part on the destination ID and the BPR signal.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

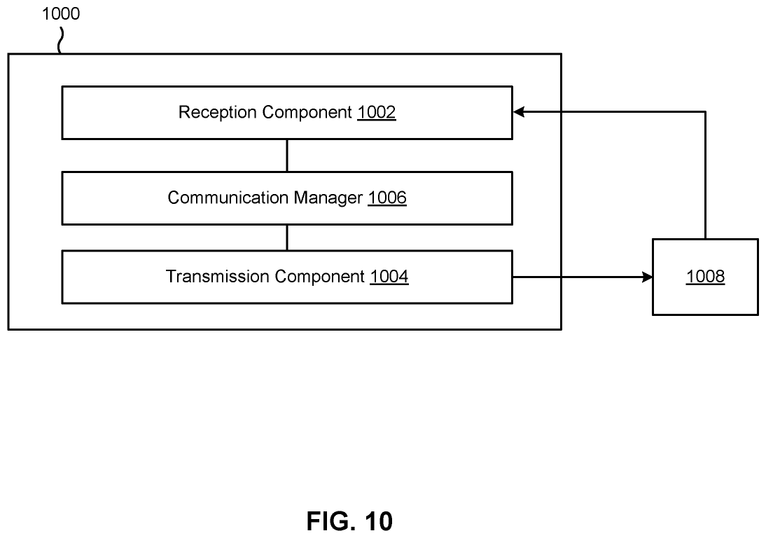

FIG. 10 is a diagram of an example apparatus 1000 for wireless communication, in accordance with the present disclosure. The apparatus 1000 may be a second UE, or a second UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIG. 6. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the second UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the second UE described in connection with FIG. 2.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the second UE described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive an IBP-RS based at least in part on a destination ID, wherein one or more of an IBP-RS sequence, an IBP-RS configuration, or an IBP-RS resource is based at least in part on the destination ID. The communication manager 1006 may monitor or search for the IBP-RS based at least in part on the destination ID provisioned for the second UE. The transmission component 1004 may transmit, based at least in part on the IBP-RS, a BPR signal for a beam association. The reception component 1002 may receive a DCR based at least in part on the destination ID and the BPR signal.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a first user equipment (UE), comprising: transmitting, to a second UE, a reference signal used for initial beam-pairing (IBP) (IBP-RS) based at least in part on a destination identifier (ID), wherein one or more of an IBP-RS sequence, an IBP-RS configuration, or an IBP-RS resource is based at least in part on the destination ID; and receiving, from the second UE and based at least in part on the IBP-RS, a beam-pairing response signal for a beam association.

Aspect 2: The method of Aspect 1, further comprising: transmitting, to the second UE, a direct communication request (DCR) based at least in part on the destination ID and the beam-pairing response signal.

Aspect 3: The method of any of Aspects 1-2, wherein the destination ID is a layer-2 ID of the second UE based at least in part on the second UE being a target UE.

Aspect 4: The method of any of Aspects 1-3, wherein the destination ID is a service ID associated with a proximity services (ProSe) service ID.

Aspect 5: The method of any of Aspects 1-4, wherein the destination ID is a service ID associated with a vehicle-to-vehicle (V2V) service ID.

Aspect 6: The method of any of Aspects 1-5, wherein a scrambling or sequence ID of the IBP-RS is based at least in part on the destination ID.

Aspect 7: The method of Aspect 6, wherein the scrambling or sequence ID is based at least in part on a decimal representation of the destination ID.

Aspect 8: The method of Aspect 6, wherein the scrambling or sequence ID is based at least in part on a cyclic redundancy check (CRC) of sidelink control information (SCI) associated with the IBP-RS and the destination ID.

Aspect 9: The method of Aspect 6, wherein the scrambling or sequence ID is based at least in part on a concatenation of: a defined quantity of bits of a cyclic redundancy check (CRC) of sidelink control information (SCI) associated with the IBP-RS, and a defined quantity of bits of the destination ID.

Aspect 10: The method of any of Aspects 1-9, wherein a scrambling or sequence ID of the IBP-RS is based at least in part on a Z-bit random factor.

Aspect 11: The method of any of Aspects 1-10, wherein the destination ID is associated with a Z-bit random factor, and one or more of a scrambling or sequence ID of the IBP-RS, the IBP-RS configuration, or the IBP-RS resource is based at least in part on the destination ID associated with the Z-bit random factor.

Aspect 12: The method of any of Aspects 1-11, wherein one or more of a scrambling or sequence ID of the IBP-RS, the IBP-RS configuration, or the IBP-RS resource is based at least in part on a source ID of the first UE and the destination ID, and the source ID is mapped to a service ID.

Aspect 13: The method of any of Aspects 1-12, wherein the beam-pairing response signal is associated with one of: a physical sidelink feedback channel (PSFCH), a sidelink channel state information reference signal (SL CSI-RS), a sidelink synchronization signal block (S-SSB), a physical sidelink control channel (PSCCH), or the IBP-RS.

Aspect 14: The method of any of Aspects 1-13, wherein a resource or a sequence associated with the beam-pairing response signal is independent of the destination ID of the second UE.

Aspect 15: The method of any of Aspects 1-14, wherein a resource or a sequence associated with the beam-pairing response signal is based at least in part on a resource ID of the IBP-RS or a scrambling or sequence ID of the IBP-RS.

Aspect 16: The method of any of Aspects 1-15, wherein the IBP-RS based at least in part on the destination ID is associated with a unicast link establishment between the first UE and the second UE.

Aspect 17: The method of any of Aspects 1-16, wherein the IBP-RS based at least in part on the destination ID is associated with an IBP for sidelink broadcast communication.

Aspect 18: The method of any of Aspects 1-17, wherein the IBP-RS based at least in part on the destination ID is associated with an IBP for sidelink groupcast communication.

Aspect 19: The method of any of Aspects 1-18, wherein the IBP-RS based at least in part on the destination ID is associated with an IBP for direct or UE-to-network discovery.

Aspect 20: The method of any of Aspects 1-19, wherein the IBP-RS based at least in part on the destination ID is associated with an IBP for direct or UE-to-network group discovery.

Aspect 21: A method of wireless communication performed by a second user equipment (UE), comprising: receiving, from a first UE, a reference signal used for initial beam-pairing (IBP) (IBP-RS) based at least in part on a destination identifier (ID), wherein one or more of an IBP-RS sequence, an IBP-RS configuration, or an IBP-RS resource is based at least in part on the destination ID; and transmitting, to the first UE and based at least in part on the IBP-RS, a beam-pairing response signal for a beam association.

Aspect 22: The method of Aspect 21, further comprising: receiving, from the first UE, a direct communication request (DCR) based at least in part on the destination ID and the beam-pairing response signal.

Aspect 23: The method of any of Aspects 21-22, further comprising: monitoring or searching for the IBP-RS based at least in part on the destination ID provisioned for the second UE.

Aspect 24: The method of any of Aspects 21-23, wherein the destination ID is a layer-2 ID of the second UE based at least in part on the second UE being a target UE.

Aspect 25: The method of any of Aspects 21-24, wherein the destination ID is a service ID associated with a proximity services (ProSe) service ID.

Aspect 26: The method of any of Aspects 21-25, wherein the destination ID is a service ID associated with a vehicle-to-vehicle (V2V) service ID.

Aspect 27: The method of any of Aspects 21-26, wherein a scrambling or sequence ID of the IBP-RS is based at least in part on the destination ID.

Aspect 28: The method of Aspect 27, wherein the scrambling or sequence ID is based at least in part on a decimal representation of the destination ID.

Aspect 29: The method of Aspect 27, wherein the scrambling or sequence ID is based at least in part on a cyclic redundancy check (CRC) of sidelink control information (SCI) associated with the IBP-RS and the destination ID.

Aspect 30: The method of Aspect 27, wherein the scrambling or sequence ID is based at least in part on a concatenation of: a defined quantity of bits of a cyclic redundancy check (CRC) of sidelink control information (SCI) associated with the IBP-RS, and a defined quantity of bits of the destination ID.

Aspect 31: The method of any of Aspects 21-30 wherein a scrambling or sequence ID of the IBP-RS is based at least in part on a Z-bit random factor.

Aspect 32: The method of any of Aspects 21-31, wherein the destination ID is associated with a Z-bit random factor, and one or more of a scrambling or sequence ID of the IBP-RS, the IBP-RS configuration, or the IBP-RS resource is based at least in part on the destination ID associated with the Z-bit random factor.

Aspect 33: The method of any of Aspects 21-32, wherein one or more of a scrambling or sequence ID of the IBP-RS, the IBP-RS configuration, or the IBP-RS resource is based at least in part on a source ID of the first UE and the destination ID, and the source ID is mapped to a service ID.

Aspect 34: The method of any of Aspects 21-33, wherein the beam-pairing response signal is associated with one of: a physical sidelink feedback channel (PSFCH), a sidelink channel state information reference signal (SL CSI-RS), a sidelink synchronization signal block (S-SSB), a physical sidelink control channel (PSCCH), or the IBP-RS.

Aspect 35: The method of any of Aspects 21-34, wherein a resource or a sequence associated with the beam-pairing response signal is independent of the destination ID of the second UE.

Aspect 36: The method of any of Aspects 21-35, wherein a resource or a sequence associated with the beam-pairing response signal is based at least in part on a resource ID of the IBP-RS or a scrambling or sequence ID of the IBP-RS.

Aspect 37: The method of any of Aspects 21-36, wherein the IBP-RS based at least in part on the destination ID is associated with a unicast link establishment between the first UE and the second UE.

Aspect 38: The method of any of Aspects 21-37, wherein the IBP-RS based at least in part on the destination ID is associated with an IBP for sidelink broadcast communication.

Aspect 39: The method of any of Aspects 21-38, wherein the IBP-RS based at least in part on the destination ID is associated with an IBP for sidelink groupcast communication.

Aspect 40: The method of any of Aspects 21-39, wherein the IBP-RS based at least in part on the destination ID is associated with an IBP for direct or UE-to-network discovery.

Aspect 41: The method of any of Aspects 21-40, wherein the IBP-RS based at least in part on the destination ID is associated with an IBP for direct or UE-to-network group discovery.

Aspect 42: An apparatus for wireless communication at a device, comprising a processor; memory coupled with the processor; and instructions stored in the memory and executable by the processor to cause the apparatus to perform the method of one or more of Aspects 1-20.

Aspect 43: A device for wireless communication, comprising a memory and one or more processors coupled to the memory, the one or more processors configured to perform the method of one or more of Aspects 1-20.

Aspect 44: An apparatus for wireless communication, comprising at least one means for performing the method of one or more of Aspects 1-20.

Aspect 45: A non-transitory computer-readable medium storing code for wireless communication, the code comprising instructions executable by a processor to perform the method of one or more of Aspects 1-20.

Aspect 46: A non-transitory computer-readable medium storing a set of instructions for wireless communication, the set of instructions comprising one or more instructions that, when executed by one or more processors of a device, cause the device to perform the method of one or more of Aspects 1-20.

Aspect 47: An apparatus for wireless communication at a device, comprising a processor; memory coupled with the processor; and instructions stored in the memory and executable by the processor to cause the apparatus to perform the method of one or more of Aspects 21-41.

Aspect 48: A device for wireless communication, comprising a memory and one or more processors coupled to the memory, the one or more processors configured to perform the method of one or more of Aspects 21-41.

Aspect 49: An apparatus for wireless communication, comprising at least one means for performing the method of one or more of Aspects 21-41.

Aspect 50: A non-transitory computer-readable medium storing code for wireless communication, the code comprising instructions executable by a processor to perform the method of one or more of Aspects 21-41.

Aspect 51: A non-transitory computer-readable medium storing a set of instructions for wireless communication, the set of instructions comprising one or more instructions that, when executed by one or more processors of a device, cause the device to perform the method of one or more of Aspects 21-41.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c” is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. An apparatus for wireless communication at a first user equipment (UE), comprising:
one or more memories; and
one or more processors coupled to the one or more memories, the one or more processors individually or collectively configured to:
transmit, to a second UE, a reference signal used for initial beam-pairing (IBP) (IBP-RS) based at least in part on a destination identifier (ID), wherein one or more of an IBP-RS sequence, an IBP-RS configuration, or an IBP-RS resource is based at least in part on the destination ID; and
receive, from the second UE and based at least in part on the IBP-RS, a beam-pairing response signal for a beam association.

2. The apparatus of claim 1, wherein the one or more processors are further individually or collectively configured to:
transmit, to the second UE, a direct communication request (DCR) based at least in part on the destination ID and the beam-pairing response signal.

3. The apparatus of claim 1, wherein:
the destination ID is a layer-2 ID of the second UE based at least in part on the second UE being a target UE;
the destination ID is a service ID associated with a proximity services (ProSe) service ID; or
the destination ID is a service ID associated with a vehicle-to-vehicle (V2V) service ID.

4. The apparatus of claim 1, wherein a scrambling or sequence ID of the IBP-RS is based at least in part on the destination ID.

5. The apparatus of claim 4, wherein the scrambling or sequence ID is based at least in part on a decimal representation of the destination ID.

6. The apparatus of claim 4, wherein the scrambling or sequence ID is based at least in part on a cyclic redundancy check (CRC) of sidelink control information (SCI) associated with the IBP-RS and the destination ID.

7. The apparatus of claim 4, wherein the scrambling or sequence ID is based at least in part on a concatenation of: a defined quantity of bits of a cyclic redundancy check (CRC) of sidelink control information (SCI) associated with the IBP-RS, and a defined quantity of bits of the destination ID.

8. The apparatus of claim 1, wherein a scrambling or sequence ID of the IBP-RS is based at least in part on a Z-bit random factor.

9. The apparatus of claim 1, wherein the destination ID is associated with a Z-bit random factor, and one or more of a scrambling or sequence ID of the IBP-RS, the IBP-RS configuration, or the IBP-RS resource is based at least in part on the destination ID associated with the Z-bit random factor.

10. The apparatus of claim 1, wherein one or more of a scrambling or sequence ID of the IBP-RS, the IBP-RS configuration, or the IBP-RS resource is based at least in part on a source ID of the first UE and the destination ID, and the source ID is mapped to a service ID.

11. The apparatus of claim 1, wherein the beam-pairing response signal is associated with one of: a physical sidelink feedback channel (PSFCH), a sidelink channel state information reference signal (SL CSI-RS), a sidelink synchronization signal block (S-SSB), a physical sidelink control channel (PSCCH), or the IBP-RS.

12. The apparatus of claim 1, wherein a resource or a sequence associated with the beam-pairing response signal is independent of the destination ID of the second UE.

13. The apparatus of claim 1, wherein a resource or a sequence associated with the beam-pairing response signal is based at least in part on a resource ID of the IBP-RS or a scrambling or sequence ID of the IBP-RS.

14. The apparatus of claim 1, wherein the IBP-RS based at least in part on the destination ID is associated with a unicast link establishment between the first UE and the second UE.

15. The apparatus of claim 1, wherein:
the IBP-RS based at least in part on the destination ID is associated with an IBP for sidelink broadcast communication; or
the IBP-RS based at least in part on the destination ID is associated with an IBP for sidelink groupcast communication.

16. The apparatus of claim 1, wherein:
the IBP-RS based at least in part on the destination ID is associated with an IBP for direct or UE-to-network discovery; or
the IBP-RS based at least in part on the destination ID is associated with an IBP for direct or UE-to-network group discovery.

17. An apparatus for wireless communication at a second user equipment (UE), comprising:
one or more memories; and
one or more processors coupled to the one or more memories, the one or more processors individually or collectively configured to:
receive, from a first UE, a reference signal used for initial beam-pairing (IBP) (IBP-RS) based at least in part on a destination identifier (ID), wherein one or more of an IBP-RS sequence, an IBP-RS configuration, or an IBP-RS resource is based at least in part on the destination ID; and
transmit, to the first UE and based at least in part on the IBP-RS, a beam-pairing response signal for a beam association.

18. The apparatus of claim 17, wherein the one or more processors are further individually or collectively configured to:
receive, from the first UE, a direct communication request (DCR) based at least in part on the destination ID and the beam-pairing response signal.

19. The apparatus of claim 17, wherein the one or more processors are further individually or collectively configured to:
monitor or search for the IBP-RS based at least in part on the destination ID provisioned for the second UE.

20. A method of wireless communication performed by a first user equipment (UE), comprising:
transmitting, to a second UE, a reference signal used for initial beam-pairing (BBP) (BBP-RS) based at least in part on a destination identifier (ID), wherein one or more of an IBP-RS sequence, an IBP-RS configuration, or an IBP-RS resource is based at least in part on the destination ID; and
receiving, from the second UE and based at least in part on the IBP-RS, a beam-pairing response signal for a beam association.
